(19) United States
(12) Patent Application Publication
(10) Pub. No.: US 2024/0284208 A1
(43) Pub. Date: Aug. 22, 2024

(54) OPTIMIZED UE-TO-UE CROSS-LINK INTERFERENCE (CLI) MEASUREMENTS

(71) Applicant: Media Tek Singapore Pte. Ltd., Singapore (SG)

(72) Inventors: Sumaila Anning Mahama, Cambridge (GB); Mohammed S Aleabe Al-Imari, Cambridge (GB)

(21) Appl. No.: 18/432,219

(22) Filed: Feb. 5, 2024

Related U.S. Application Data
(60) Provisional application No. 63/485,265, filed on Feb. 16, 2023.

(51) Int. Cl. H04W 24/08; H04L 5/14; H04W 24/10

(52) U.S. Cl. CPC H04W 24/08; H04L 5/14; H04W 24/10

(57) ABSTRACT

In an aspect of the disclosure, a method, a computer-readable medium, and an apparatus are provided. The apparatus is a UE. The UE receives a sounding reference signal (SRS) configuration from a base station. The UE transmits a sounding reference signal (SRS) within a guard band (GB) frequency range in a frequency band during a subband full-duplexing (SBFD) time unit based on the SRS configuration.

### CROSS-REFERENCE TO RELATED APPLICATION(S)

This application claims the benefits of U.S. Provisional Application Ser. No. 63/485,265, entitled “OPTIMIZED UE-TO-UE CLI MEASUREMENTS” and filed on Feb. 16, 2023, which is expressly incorporated by reference herein in its entirety.

### BACKGROUND

### Field

The present disclosure relates generally to communication systems, and more particularly, to techniques of CLI measurement and reporting at a user equipment (UE).

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is a UE. The UE receives a sounding reference signal (SRS) configuration from a base station. The UE transmits a sounding reference signal (SRS) within a guard band (GB) frequency range in a frequency band during a subband full-duplexing (SBFD) time unit based on the SRS configuration.

In another aspect of the disclosure, a method, a computer-readable medium, and an apparatus are provided. The apparatus is a UE. The UE receives a sounding reference signal (SRS) reference signal received power (RSRP) measurement configuration from a base station. The UE performs SRS-RSRP measurements within a guard band (GB) in a frequency band during a subband full-duplexing (SBFD) time unit, as specified by the received SRS-RSRP measurement configuration. The UE reports the results of the SRS-RSRP measurements to the base station.

In yet another aspect of the disclosure, a method, a computer-readable medium, and an apparatus are provided. The apparatus is a UE. The UE receives a configuration from a base station that indicates one or more resource block (RB) groups within an uplink subband of a subband full-duplexing (SBFD) time unit where cross-link interference (CLI) measurements should be performed. The UE performs the CLI measurements within the uplink subband on the indicated one or more RB groups during the SBFD time unit. The UE reports the results of the CLI measurements to the base station, and the results include one or more RB group indices to indicate the one or more RB groups on which CLI was measured.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating communications among a base station and multiple UEs.

FIG. 8 is a diagram illustrating a first method of cross-link interference (CLI) measurement and reporting mechanism.

FIG. 9 is a diagram illustrating a second method of CLI measurement and reporting mechanism.

FIG. 10 is a flow chart of a method (process) for managing sounding reference signal (SRS) transmissions within a guard band (GB) frequency range during subband full-duplexing (SBFD) time units.

FIG. 11 is a flow chart of a method for sounding reference signal (SRS) reference signal received power (RSRP) measurement within a guard band (GB).

FIG. 12 is a flow chart of a method for performing cross-link interference (CLI) measurements and reporting the measurement results to a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

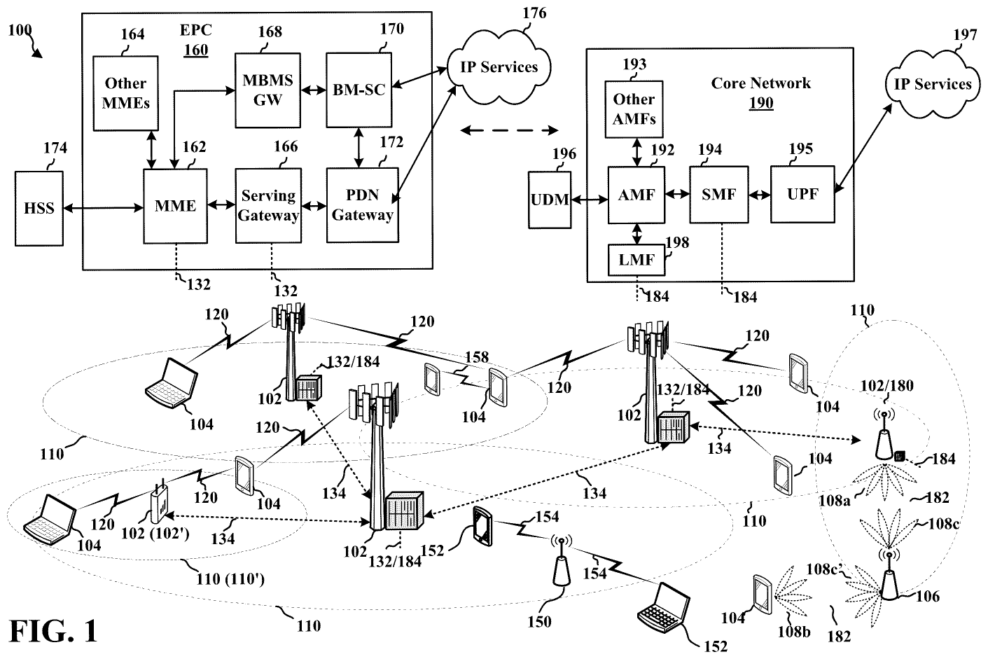

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

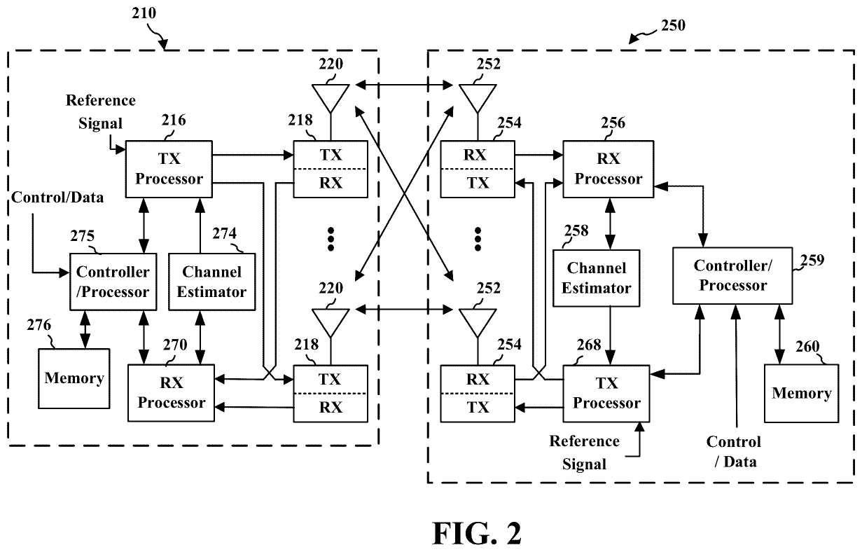

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

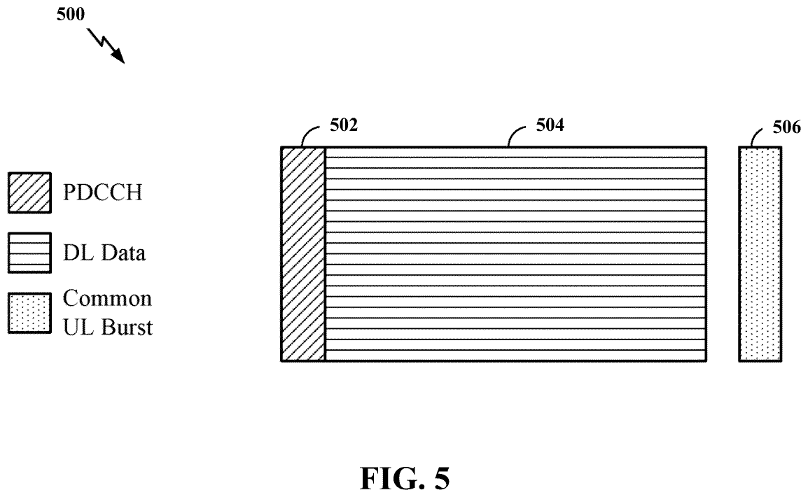

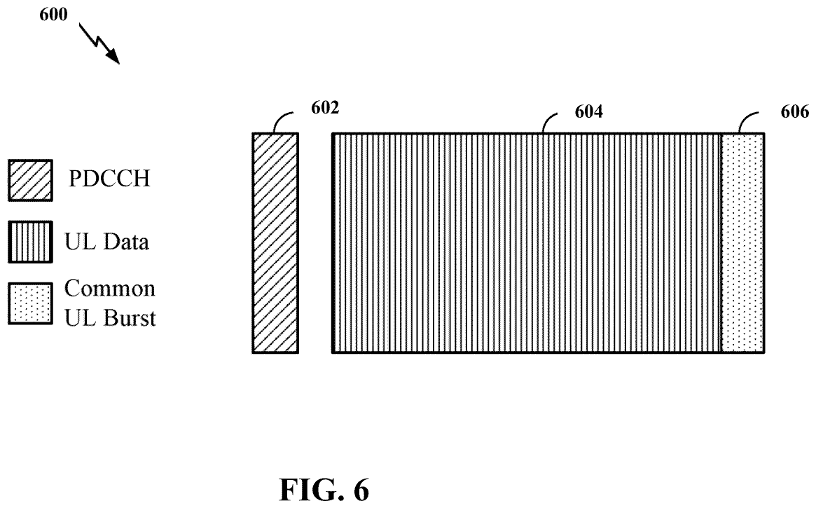

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

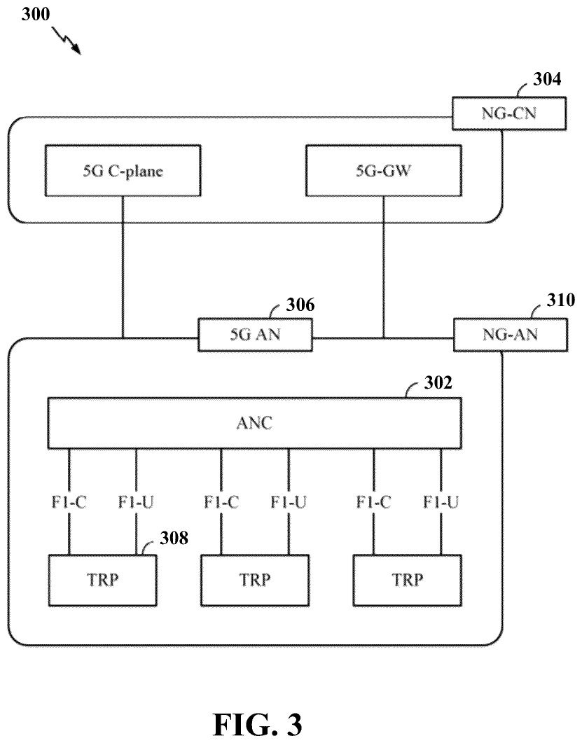

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

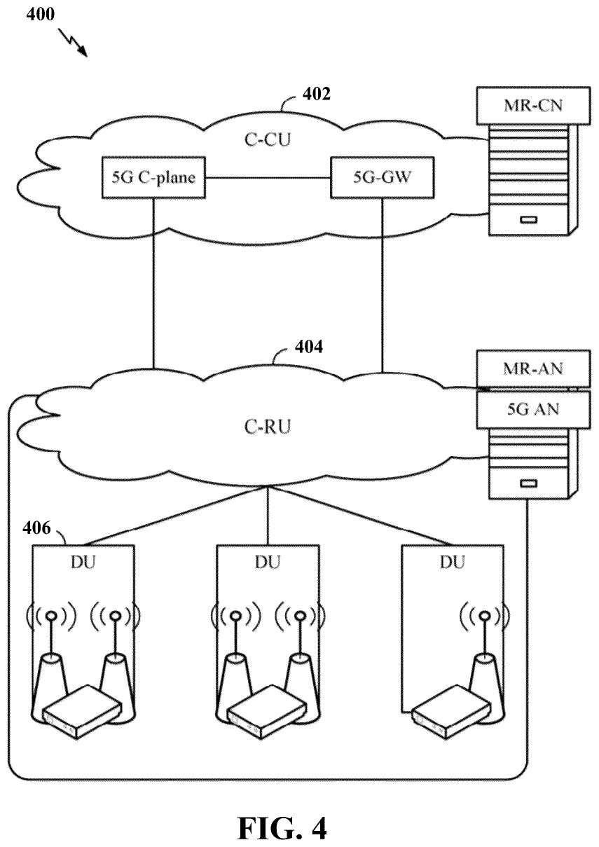

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

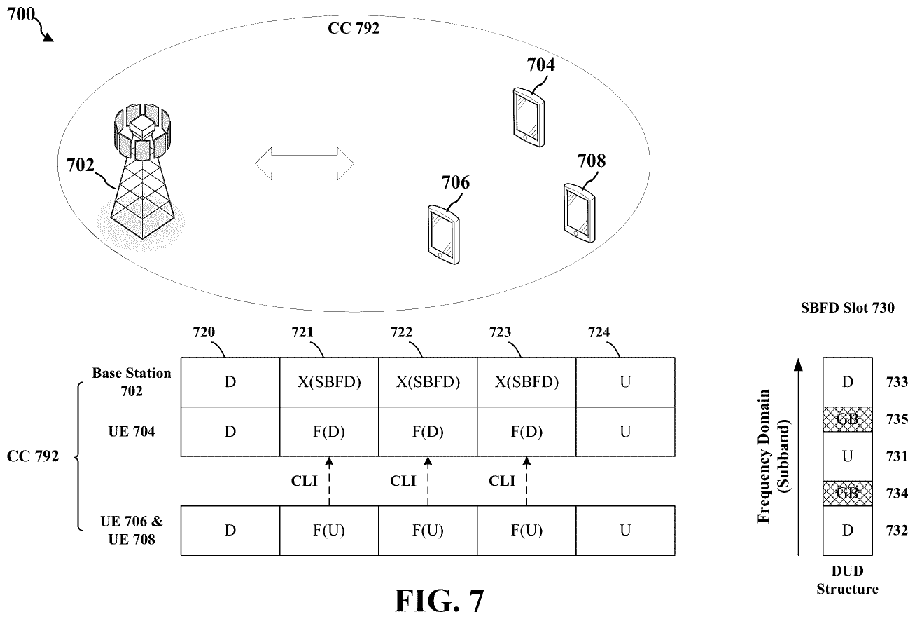

FIG. 7 is a diagram 700 illustrating communications among a base station 702 and multiple UEs 704, 706, and 708. The base station 702 has established one or more component carrier (CCs) 792 for communications with UEs 704, 706, and 708. In this example, the base station 702 employs a Time Division Duplexing (TDD) configuration with the TDD pattern DXXXU to facilitate communication with UEs 704, 706, and 708 on the one or more CCs 792.

Specifically, in a downlink-only slot (D), the frequency resources of the slot are exclusively available for DownLink (DL) transmissions. The base station 702 transmits Radio Frequency (RF) signals to UEs 704, 706, and 708 on the one or more CCs 792. Conversely, in an uplink-only slot (U), the frequency resources of the slot are exclusively available for UpLink (UL) transmissions. UEs 704, 706, and 708 transmit RF signals to the base station 702 on the one or more CCs 792.

An ‘X’ represents a SubBand Full-Duplexing (SBFD) slot. In an SBFD slot, the frequency resources of the slot are shared for both DL and UL transmissions. The DL and UL subbands within an SBFD slot are non-overlapping, and a GuardBand (GB) may be necessary between the DL and UL subbands to ensure sufficient isolation.

Further, in this example, the SBFD subband is configured with a DUD pattern. More specifically, a SBFD slot 730 includes an UL subband 731 at the center of the channel bandwidth, two DL subbands 732 and 733 on either side of the channel bandwidth, and GB subbands 734 and 735 separating the DL subbands 732 and 733 from the UL subband 731.

The following parameters are used to describe the SBFD subband configuration:
N_{D}: the number of Resource Blocks (RBs) in one DL subband.
N_{U}: the number of RBs in one UL subband.
N_{G}: the number of RBs in one GB subband between a UL subband and a DL subband.

In this example, according to the TDD pattern DXXXU, at the base station 702's side, DL transmission occurs in slots 720, SBFD occurs in slots 721, 722, and 723, and UL transmission occurs in slot 724. UEs 704, 706, and 708 are SBFD unaware. For SBFD unaware UEs 704, 706, and 708, an SBFD slot is a partitioned slot, and is used for either DL-only or UL-only. In this example, UE 704 is configured with the actual TDD pattern being DDDDU. According to this TDD pattern, at UE 704's side, DL transmission occurs in slots 720, 721, 722, and 723, and UL transmission occurs in slot 724. UEs 706 and 708 are configured with the actual TDD pattern being DUUUU. According to this TDD pattern, at UEs 706 and 708's side, DL transmission occurs in slot 720, and UL transmission occurs in slots 721, 722, 723, and 724.

In SBFD slots 721, 722, and 723, the UE 704, which is receiving RF signals from the base station 702, and the UEs 706 and 708, which are transmitting RF signals to the base station 702, operate in the same frequency band according to the SBFD frame structure. This concurrent operation causes inter-UE Cross-Link Interference (CLI), potentially degrading the reception quality of UE 704 during SBFD slots. Therefore, mechanisms for measuring the CLI information for UE 704 during SBFD slots are necessary at the base station 702 to inform resource scheduling decisions.

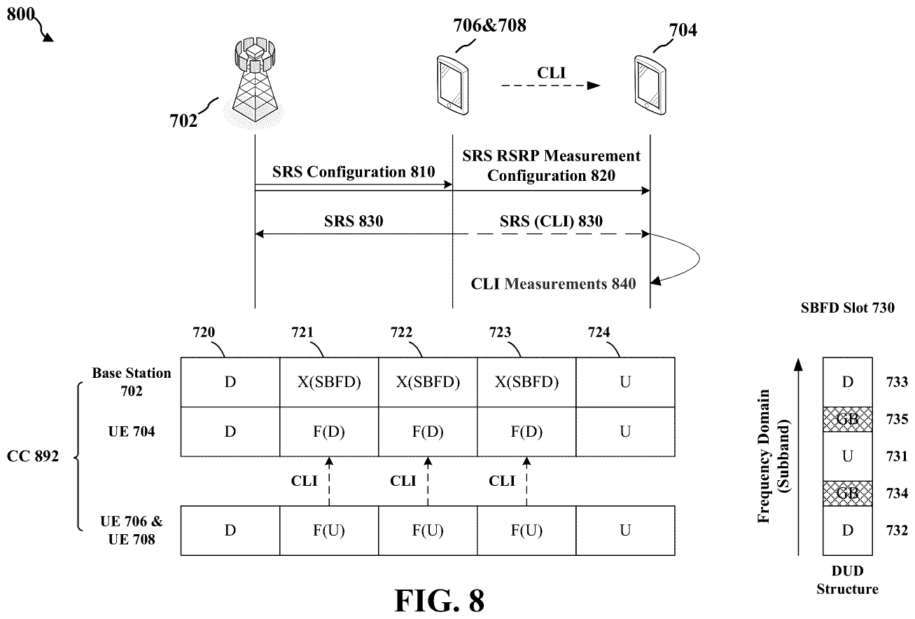

FIG. 8 illustrates a method of Cross-Link Interference (CLI) measurement mechanism using Sounding Reference Signal (SRS) Reference Signal Received Power (RSRP) measurement in Guard Band (GB) resources. The base station 702 determines an SRS configuration 810 and notifies the SRS configuration 810 to the UEs 706 and/or 708 via, e.g., Radio Resource Control (RRC) messages. The base station 702 also transmits an SRS RSRP measurement configuration 820 to the UE 704 via, e.g., RRC messages. The UEs 706 and/or 708 transmit SRS 830 on SRS resources periodically, aperiodically, or semi-persistently, as instructed by the SRS configuration 810. The UE 704 receives the SRS 830 and performs SRS RSRP measurement 840 according to the SRS RSRP measurement configuration 820.

In a first scheme, the SRS Configuration 810 specifies SRS bandwidth, indicating the frequency range over which the SRS 830 is transmitted. This can be up to 272 Resource Blocks (RBs), configurable in multiples of 4 RBs and up to 14 symbols. The SRS Configuration 810 further specifies a comb factor, which is the interval of frequency domain resources shared by multiple UEs. The comb factor can be configured as 2, 4, or 8, allowing for multiplexing of SRS along the frequency domain. The SRS Configuration 810 also specifies the repetition rate of the SRS. Configurations can be aperiodic, semi-persistent, or periodic.

In the first scheme, the UE 704 may be informed of SRS RSRP Measurement Configuration 820 from an information element called MeasObjectCLI, which provides cli-ResourceConfig, which in turn provides srs-ResourceConfigCLI. The srs-ResourceConfigCLI specifies the SRS resources to be used for CLI measurement. When using SRS resources for CLI measurements, certain restrictions apply:
Number of antenna ports in the SRS resource configured for measurement is 1.
Number of symbols in the SRS resource configured for measurement is 1.
Number of repetitions in the SRS resource configured for measurement is 1.
Frequency hopping is disabled for the SRS resource configured for measurement.
Only ‘periodic’ resource type is applicable.

SRS resources configured for SRS-RSRP based CLI measurements can lead to high resource overhead as they need to be allocated for both the transmitting UEs (706 and/or 708) and the measurement UE (704).

In a second scheme, to avoid such overhead in SubBand Full-Duplexing (SBFD) operation, SRS-RSRP measurement may be performed within a GB. The guard band, serving as a frequency gap between the DownLink (DL) and UpLink (UL) subbands and typically left unused, is utilized to reduce resource overhead while still allowing for effective CLI measurements. This efficient use of GB resources ensures that the rest of the frequency band can be used for DL or UL transmission without interference.

In one example according to the second scheme, the UEs 706 and 708 are allocated SRS resources within the frequency ranges corresponding to the GB subbands 734 and 735. These allocations may be periodic or semi-persistent. DownLink (DL)-only slot 720 and the UpLink (UL)-only slot 724 are non-partitioned slots. Conversely, the SubBand Full-Duplexing (SBFD) slots 721, 722, and 723 are partitioned slots. In certain configurations, SRS transmission within a GB is supported for specific sets of slots/symbols. In particular, the SRS allocations are for partitioned slots or symbols, as they would overlap with other scheduled transmissions in the DL-only slot 720 and the UL-only slot 724. SRS transmissions within a GB cannot be configured on the DL-only slot 720 or on the UL-only slot 724, as no GB subbands are available in these slots. Therefore, SRS transmission within a GB is supported for specific sets of slots/symbols. SRS transmissions within a GB are only feasible for the SBFD slots 721, 722, and 723. Within these slots, SRS resources for CLI measurement can be configured within the two GB subbands 734 and 735.

A GB may be structured such that resources of each GB form a contiguous block in the frequency domain, allowing each GB to have its own dedicated SRS configuration. For example, the base station 702 can configure separate SRS configurations for each of these GB subbands. For instance, GB subband 734 might have a different SRS configuration than GB subband 735. This allows the base station 702 to tailor the SRS transmissions based on the specific interference mitigation needs of the adjacent DL and UL subbands. Further, SRS transmissions within GB subband 734 can be configured for UE 706, while GB subband 735 can be configured for SRS transmissions by UE 708.

Alternatively, the GB subbands 734 and 735 may form a single GB that has non-contiguous resources in the frequency domain, with frequency gaps or non-overlapping segments within the GB. Despite this non-contiguous arrangement, a single SRS configuration can be employed for transmissions within the single GB. The base station 702 uses a single SRS Configuration 810 to manage SRS transmissions within the single GB.

New SRS configurations are designed to support SRS transmission within the GB subbands. These configurations allow for a flexible SRS bandwidth allocation, where the number of Resource Blocks (RBs) can be other than multiples of 4, thus enabling RB allocation within a GB. That is, in the GB subband 734 and GB subband 735, the base station 702 may configure SRS resources with two, three, or other number of RBs. This flexibility would allow for more efficient use of the guard band resources, as it enables the use of all available RBs within the GB, even if they do not conform to the typical multiple-of-four rule.

A transmission comb factor of 1 is also supported for SRS transmission within a GB. A comb factor of one implies that the SRS resources are not shared among multiple UEs but are instead dedicated to a single UE. This means that if UE 706 or UE 708 were to occupy the resources in the guard band for SRS transmission, they would do so without sharing these resources with other UEs.

Further, the base station 702 may map a new SRS sequence to SRS resources in both the time and frequency domains. This sequence can be mapped to different symbols and can be repeated over multiple symbols. This new SRS sequence can be mapped to different symbols within the guard band. For example, the same SRS sequence can be transmitted by UE 706/708 on multiple symbols within GB subband 734 of slots 721-723. Additionally, the sequence can be repeated by having UE 708 transmit the same sequence over multiple symbols in GB subband 735.

In one example, the base station 702 configures UEs 706 and 708 with an SRS Configuration 810 to transmit SRS in the GB subbands 734 and 735 during the SBFD slots 721-723. Since the guard band has a limited number of resource blocks (RBs) available, the SRS resource allocation within the GB may be smaller (shorter in frequency) compared to a typical SRS configuration that uses uplink bandwidth. Additionally, multiple symbols within the GB can be allocated for SRS transmission to compensate for the reduced bandwidth. This shorter frequency allocation and potential use of multiple symbols impacts the sequence generation for the SRS.

Specifically, the SRS sequence length depends on the allocated RBs and symbols. So if fewer RBs are allocated in the GB, and SRS transmission occurs over multiple symbols, the base station 702 may generate an SRS sequence that fits this time-frequency allocation within the guard band.

For example, a single SRS sequence can be mapped over multiple symbols by UE 706 in GB subband 734. The sequence will be designed to match the shorter frequency allocation in GB subband 734 while repeating over multiple symbols.

In certain configurations, the UE 706/708 may skip SRS transmissions that are configured to occur within a Guard Band (GB) and that would overlap with non-partitioned slots or symbols.

The base station 702 determines when SRS transmissions should be skipped based on the TDD (Time Division Duplexing) configuration. For example, if the base station 702 has configured SRS transmission within a GB for UE 706 and UE 708, and this transmission is scheduled to occur during a DL-only slot 720 or a UL-only slot 724, the transmission must be skipped because these slots do not support GB operations.

To inform the UE 706/708 about when to skip the SRS transmissions, the base station 702 uses a higher layer parameter. This parameter is communicated to the UEs via control signaling, such as Radio Resource Control (RRC) messages. The parameter indicates the specific sets of slots where SRS transmissions should not occur.

One way to convey this information is through the use of a bitmap. A bitmap is a data structure that can efficiently represent the sets of slots with binary values, where each bit corresponds to a specific slot. For example, if a bit is set to ‘1’, it indicates that SRS transmission should be skipped in the corresponding slot; if it is ‘0’, the transmission can proceed as scheduled.

Sounding Reference Signal—Reference Signal Received Power (SRS-RSRP) Measurements are used to estimate the received power level of Sounding Reference Signals transmitted by other UEs. SRS-RSRP measurements are performed using specific SRS resources that are transmitted by aggressor UEs and configured by the base station. These resources are defined in terms of bandwidth, frequency range, comb factor, and repetition rate. The victim UE performing the measurement is configured to measure the average power of the received SRS on designated resources within the Guard Band (GB) during SubBand Full-Duplexing (SBFD) slots. SRS resources can be transmitted periodically, aperiodically, or semi-persistently, and are typically configured with certain restrictions, such as a single antenna port, a single symbol, and no frequency hopping, to facilitate consistent and accurate power measurements.

Similar to SRS resources, for SRS-RSRP measurement resources allocated to UE 704, the resources may be configured periodically within the frequency ranges corresponding to the GB subbands 734 and 735. As with SRS transmissions, the SRS RSRP measurements within a GB cannot be configured on the DL-only slot 720 or the UL-only slot 724 due to the absence of GB subbands in these slots. Accordingly, SRS-RSRP measurement within a GB is supported for specific sets of slots/symbols. In this example, the SRS RSRP measurement within a GB is only possible for the SBFD slots 721, 722, and 723. The SRS RSRP measurement resources for CLI measurement can be configured within the two GB subbands 734 and 735 of the SBFD slots.

In one example, the base station 702 configures SRS resources for both transmission by the UE 706 and UE 708 and measurement by the UE 704. Each SRS resource used for these purposes is assigned a unique identifier (ID). When UE 704 performs measurements on the SRS resources and reports back to the base station 702, it includes the ID of the SRS resource. This enables the base station 702 to know precisely which SRS resource was used for the measurement and to identify which SRS resource was causing interference, based on the resource IDs.

A GB may allow for contiguous or non-contiguous resource blocks in the frequency domain. In the case of contiguous resources, different measurements can be performed in the two GB subbands, such as measuring the CLI caused by UE 706 in GB subband 734 and the CLI caused by UE 708 in GB subband 735.

In the case of non-contiguous resources, the CLI caused by a single UE, for example, UE 706, can be measured in both GB subbands, with the measurement results from both GB subbands aggregated to assess the overall impact of the CLI.

Similar to SRS resources, new SRS RSRP measurement resources are also designed to support measurements within the GB subbands. These resources allow for a flexible number of RBs, not limited to multiples of 4, for allocation within a GB. Additionally, a higher number of symbols can be configured for SRS-RSRP measurement resources within a GB. The UE 704 can be configured to perform SRS-RSRP measurements on up to 14 symbols, as opposed to just 1 symbol, to compensate for the limited frequency resources available within the GB. This necessitates relaxing the restriction of one symbol and allowing for up to 14 symbols to ensure that sufficient resources are available for accurate measurement. A comb factor of 1 is also supported for SRS RSRP measurement resources within a GB.

Further, if an SRS-RSRP measurement resource within a guardband is scheduled to occur during a non-partitioned slot (such as DL-only slot 720 or UL-only slot 724), the UE 704 may be configured to skip the SRS-RSRP measurement resource, because the guardband does not exist in these slots, and thus the resource is not available for measurement.

To manage this process, the base station 702 communicates with UE 704 using higher layer parameters, which indicate when to skip the SRS-RSRP measurements. Accordingly, the UE 704 does not attempt to measure SRS-RSRP in slots where no guardband is present, as this would lead to inaccurate measurements and potential mismanagement of interference.

In one configuration, the base station 702 may use a bitmap to indicate the sets of slots where skipping should be applied. Each bit of the bitmap corresponds to a specific slot. If a bit is set to ‘1’, it indicates that the SRS-RSRP measurement should be skipped for that slot; if it is ‘0’, the measurement can proceed.

The base station 702 would define this bitmap in accordance with the TDD configuration and communicate it to UE 704 as part of the SRS RSRP Measurement Configuration 820.

As such, in the examples described supra, the base station 702 uses the SRS Configuration 810 to manage the transmission of SRS by UEs 706 and 708 and the SRS RSRP Measurement Configuration 820 to guide UE 704 on when and where to perform interference measurements. The process is optimized to ensure that measurements are only taken in slots with guardbands (SBFD slots 721, 722, 723) and skipped in non-partitioned slots (DL-only slot 720 and UL-only slot 724) to maintain the accuracy and reliability of the interference assessment.

The UE 704, which is configured as a downlink-centric device, is equipped with CLI-RSSI measurement resources 910 to assess the interference levels in the UL subband 731 during SBFD operation. These resources are allocated by the base station 702 and are defined by an information element called MeasObjectCLI, which provides the RSSI-ResourceConfigCLI. The configuration allows for a granularity of multiple of 4 Resource Blocks (RBs) and up to 14 symbols, with periodicity and offset defined in terms of the number of slots.

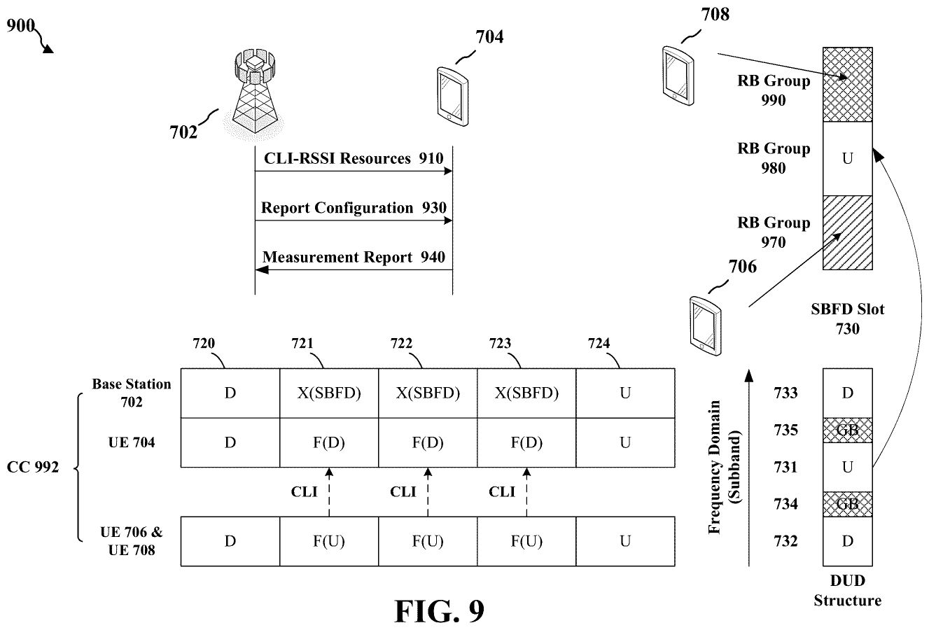

FIG. 9 is a diagram 900 illustrating a method of CLI measurement mechanism—CLI received signal strength indicator (RSSI) measurement over groups of RBs within UL subband. CLI-RSSI measurements assess the level of interference experienced by a UE due to transmissions from other UEs. This type of measurement helps in identifying and quantifying the interference levels across different frequency resources. CLI-RSSI measurements do not rely on specific transmission resources from other UEs; instead, the victim UE is configured to measure the average power over specified time-frequency regions within the uplink subband during its downlink reception phase. The configuration includes the granularity of resource blocks and symbols, as well as the periodicity and offset for the measurements. CLI-RSSI measurements may be used to differentiate between interference from various sources by measuring over groups of RBs within the UL subband. This allows the base station to identify individual aggressor UEs based on the reported interference levels from different RB groups.

In a first approach of CLI-RSSI (Received Signal Strength Indicator) measurement, the base station 702 uses CLI-RSSI measurement resources 910 to configure the UE 704 to measure the average power of interference over a specified time-frequency region. The UE 704 may receive the CLI-RSSI measurement resources 910 from an information element MeasObjectCLI which provides RSSI-ResourceConfigCLI and RSSI-ResourceConfigCLI provides CLI-RSSI resources to be used for CLI measurement. The base station 702 may not be able to differentiate between different sources of interference and their respective interference levels. This means that while UE 704 can detect the presence of interference within the UL subband 731, it cannot ascertain which specific UE (e.g., UE 706 or UE 708) is the source of that interference or the relative strength of interference each aggressor UE contributes.

Further, the CLI-RSSI measurement resource can be configured as periodic by the base station 702, meaning that the measurement is scheduled to occur at regular intervals. However, in SBFD operation, these periodic CLI-RSSI measurement resources may overlap with non-partitioned slots, such as the DL-only slot 720 and the UL-only slot 724. In such cases, the UL subband 731 resources for CLI measurement are not available because the entire slot is dedicated to either downlink or uplink transmissions exclusively, and no guard bands are present to isolate the subbands. As a result, the CLI-RSSI measurements would need to be skipped during these non-partitioned slots to avoid inaccurate interference assessments.

UEs operate in a half-duplex mode, meaning they can either transmit (uplink) or receive (downlink) at any given time, but not both simultaneously. Therefore, when UE 704 is engaged in downlink reception within the DL subbands 732, 733, the corresponding uplink part of the frequency resource, specifically the UL subband 731, remains unused.

In a second approach, instead of configuring the CLI-RSSI measurement resources on downlink resources, the base station 702 re configures the CLI-RSSI measurement resources to uplink resources during the UE 704's downlink reception phase. More specifically, the UE 704 utilizes the unused UL subband 731 for interference measurement while receiving downlink data. By measuring interference on specific groups of RBs within the UL subband 731, denoted as RB groups 970, 980, and 990, the UE 704 can now assess the interference emanating from other UEs transmitting in these groups.

The base station 702 assigns specific RB groups to specific UEs for their uplink transmissions during SBFD slots 721, 722, and 723. For example, the UE 706 may be allocated RB group 970, and UE 708 may be allocated RB group 990. When UE 704 reports the interference measurements using the report configuration 930, it includes the index of the RB groups where high levels of interference were measured, as detailed in the measurement report 940. This allows the base station 702 to correlate the interference reported by UE 704 with the uplink transmissions of UEs 706 and 708, thereby identifying the aggressors causing the interference.

In the second approach, the UE 704 performs CLI-RSSI measurements over the specified time-frequency resources and generates a measurement report 940 based on the observed interference. The report configuration 930 instructs the UE 704 on the details to be included in the measurement report. The UE 704 may report the group index of the RBs where the CLI measurement occurs, such as the RB groups 970, 980, and 990 within the UL subband 731.

Additionally, the UE 704 may report the index of the RB with the maximum CLI among the group of RBs, as well as the indices of RBs where the CLI exceeds a predefined threshold.

The base station 702 configures specific RB groups, such as RB groups 970, 980, and 990, to be allocated to particular UEs for transmission. For instance, UE 706 may be assigned to transmit on RB group 970, while UE 708 may be assigned to RB group 990. This frequency differentiation enables the base station 702 to identify the aggressor UEs causing the interference, as reported by UE 704. The CLI-RSSI measurement resources 910 are configured to enable UE 704 to perform CLI measurements and report the findings accurately.

The measurement report 940 includes the time and frequency location of the reported CLI, allowing the base station 702 to correlate the interference with specific UEs and time-frequency resources. For example, if no uplink transmission is scheduled on a particular RB group, such as RB group 980, then UE 704 would report no CLI detected for that RB group. Conversely, if there are uplink activities on RB groups 970 and 990 by the UEs 706 and 708, the UE 704 would likely report higher levels of CLI for these RB groups. This reporting mechanism allows the base station 702 to identify which UEs are contributing to the interference and take appropriate action to mitigate it.

As described supra, in the SBFD slots 721, 722 and 723, the UE 704 can be configured by the base station 702 to measure cross link interference (CLI) over RB groups 970, 980 and 990 within its UL subband 731. These RB groups for CLI measurement follow an RBG or resource block group level configuration. In one configuration, each RB group consists of multiples of 4 RBs. As such, in this example, the RB groups 970, 980 and 990 over which the UE 704 measures CLI are made up of multiples of 4 RBs. For example, each group could contain 4 RBs, 8 RBs, 12 RBs etc. This allows frequency differentiation so that CLI can be measured separately on each group.

In certain configurations, measurement reporting may follow a legacy CLI measurement reporting procedure. In certain configurations, the measurement report includes the RB group index (index of RBs on which CLI measurement occurred). That is, the measurement report 940 provided by UE 704 will specify which group of RBs the interference measurements pertain to. This allows the base station 702 to understand which specific frequency resources are experiencing high levels of interference. The RB group index is included to indicate the group of RBs on which the reported CLI measurement occurred. For example, the UE 704 can report measured CLI for RB group 1, RB group 2, RB group 3.

In certain configurations, the measurement report includes the index of RB with maximum CLI among group of RBs. That is, the measurement report 940 indicates the specific RB within a group that has the highest level of interference. This allows the base station 702 to determine which particular RB within the group is most affected by interference.

In certain configurations, the measurement report includes the index of RB(s) with CLI higher than a predefined threshold. That is, the report 940 will also indicate any RBs within a group where the interference exceeds a certain level deemed unacceptable by the network. This threshold-based reporting ensures that only significant interference levels are communicated to the base station 702, reducing unnecessary reporting and conserving network resources. If the CLI is below the threshold, the UE 704 will not include it in the report, assuming it is not substantial enough to affect the network performance.

In certain configurations, measurement reporting includes the time and/or frequency location of the reported CLI. The detail within the report 940 includes not just the location within the frequency spectrum (the RB index) but also the timing of the interference (the slots/symbols).

In certain configurations, the UE can be configured to report the slots/symbols on which CLI was measured. In certain configurations, the UE can be configured to report the resource block(s) on which CLI was measured. That is, the base station 702 can instruct UE 704, through configurations such as the CLI-RSSI measurement resources 910 and report configuration 930, to include specific details about the timing (slots/symbols) and location (resource blocks) of the CLI measurements in its reports.

For example, when UE 704 performing CLI measurement over RB groups 970, 980, 990 in its UL subband 731 during the SBFD slots 721, 722, 723, the measurement report 940 to the base station 702 can include additional time and frequency details of where the CLI was measured. Specifically, the measurement report 940 can include the specific slots and symbols on which the UE 704 measured high CLI values. Additionally, the report can specify the specific resource blocks where high CLI was observed.

By providing this detailed time and frequency information to the base station 702, along with the measured CLI values, it can further narrow down which specific UEs (706, 708) were potentially causing interference to the victim UE 704. This is because the base station 702 has knowledge of which UEs were scheduled for UL transmission in those exact slots/symbols/resource blocks that showed high CLI in the measurement report 940 from UE 704. So it can pinpoint the aggressor UEs more accurately. As such, augmenting the measurement report 940 with precise time/frequency details aids the base station 702 in identifying CLI aggressors and mitigating that interference accordingly through scheduling.

In certain configurations, the base station 702 communicates with multiple User Equipments (UEs), such as UE 704, UE 706, and UE 708, across different slots and subbands, including DL-only slot 720, SBFD slots 721, 722, 723, and UL-only slot 724. In a scenario where CLI measurement resources within the UL subband 731, allocated to UE 704 for interference measurement, may overlap with non-partitioned slots or symbols. Non-partitioned slots are those that are designated as either exclusively for downlink (DL) or uplink (UL) transmissions, such as DL-only slot 720 and UL-only slot 724. These slots do not have the guard bands (GB subbands 734 and 735) that are typically present in SBFD slots to separate DL and UL subbands (DL subband 732 and 733, UL subband 731).

In such cases, the UE 704 may be configured to skip the CLI measurements to prevent inaccurate interference assessments. To facilitate this, the base station 702 would indicate to UE 704 when to skip the CLI measurements. This indication is provided by a higher layer parameter, which is a control message sent from the base station 702 to the UE 704, informing it of the specific slots where measurements should not be taken.

In certain configurations, the base station 702 may communicate this information is through the use of a bitmap. Each bit in the bitmap corresponds to a specific slot, and its value indicates whether the CLI measurement should be skipped (e.g., ‘1’ for skip, ‘0’ for do not skip) for that slot. For example, if the bitmap indicates to skip measurements for DL-only slot 720 and UL-only slot 724, UE 704 would not perform CLI measurements during those slots.

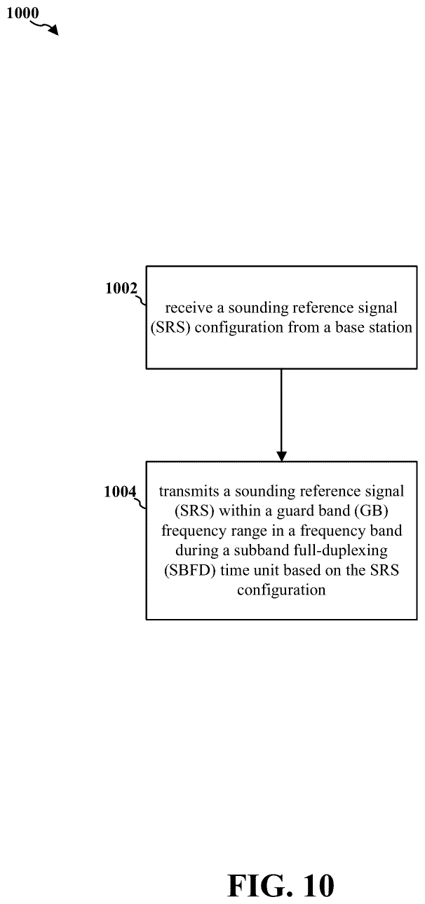

FIG. 10 is a flow chart 1000 of a method (process) for managing sounding reference signal (SRS) transmissions within a guard band (GB) frequency range during subband full-duplexing (SBFD) time units. The method may be performed by a UE (e.g., the UE 704). The method may be performed by a UE (e.g., the UE 706 or 708).

In operation 1002, the UE receives a sounding reference signal (SRS) configuration from a base station. The SRS configuration may specify a frequency range in which the SRS is to be transmitted. The frequency range may contain an integer number of resource blocks (RBs) within the GB that are other than multiples of four for RB allocation. The SRS configuration may specify a comb factor for the SRS transmission, the comb factor determining a frequency domain resource sharing interval among multiple UEs. The comb factor may be one. The SRS may be transmitted periodically, aperiodically, or semi-persistently as instructed by the SRS configuration.

In operation 1004, the UE transmits a sounding reference signal (SRS) within a guard band (GB) frequency range in a frequency band during a subband full-duplexing (SBFD) time unit based on the SRS configuration. In certain configurations, the SBFD time unit is a slot or a symbol.

In certain configurations, prior to transmitting the SRS, the UE receives, from the base station, a higher layer parameter that indicates a specific set of time units in which an SRS transmission within the GB frequency range are to be skipped. The higher layer parameter may include a bitmap that indicates the specific set of time units in which an SRS transmission is to be skipped.

In certain configurations, the UE generates an SRS sequence for transmission within the GB frequency range. The SRS sequence is mapped to SRS resources configured by the SRS configuration and capable of being repeated over multiple symbols. In certain configurations, a GB includes the GB frequency range and is contiguous in a frequency domain. The UE is configured to perform SRS transmission in the GB frequency range. In certain configurations, a GB is non-contiguous in a frequency domain and includes the GB frequency range and another frequency range. The UE is configured to perform SRS transmission in the GB frequency range and in the another frequency range.

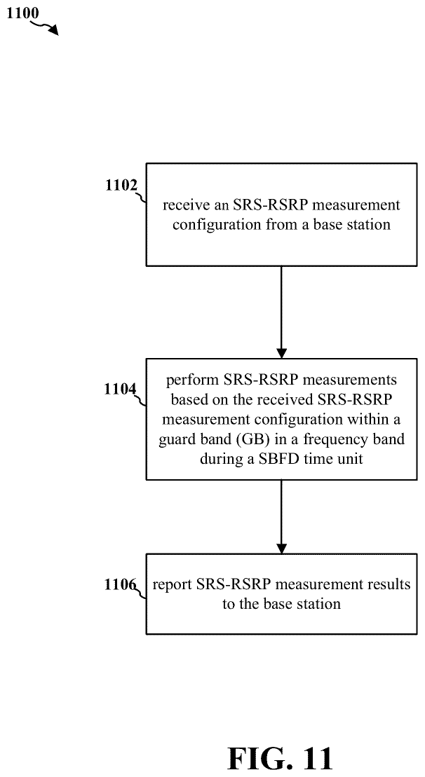

FIG. 11 is a flow chart 1100 of a method for sounding reference signal (SRS) reference signal received power (RSRP) measurement within a guard band (GB). The method may be performed by a UE (e.g., the UE 704).

In operation 1102, the UE receives an SRS-RSRP measurement configuration from a base station. In certain configurations, the SRS-RSRP measurement configuration specifies a frequency range over which the SRS-RSRP measurements are to be performed. In certain configurations, the SRS-RSRP measurement configuration indicates more than one symbol for performing the SRS-RSRP measurements. In certain configurations, the SRS-RSRP measurement configuration further specifies a comb factor for multiplexing of SRS along a frequency domain.

In operation 1104, the UE performs SRS-RSRP measurements based on the received SRS-RSRP measurement configuration within a guard band (GB) in a frequency band during a subband full-duplexing (SBFD) time unit. In certain configurations, the SBFD time unit is a slot or a symbol.

In certain configurations, the GB comprises non-contiguous frequency resources. In this scenario, the UE performs a first SRS-RSRP measurement on an SRS resource in a first portion of the GB and a second SRS-RSRP measurement on the same SRS resource in a second portion of the GB. The results of the first and second SRS-RSRP measurements are then combined to assess the overall interference level within the GB. In certain configurations, as detailed in operation 1120, the GB comprises contiguous frequency resources. Here, the UE performs a first SRS-RSRP measurement on a first SRS resource within the GB. Additionally, the UE performs a second SRS-RSRP measurement on a second SRS resource within another GB in the frequency band. This allows for the assessment of interference across different GBs within the frequency band.

In operation 1106, the UE reports SRS-RSRP measurement results to the base station. In certain configurations, the SRS-RSRP measurement results include an identifier (ID) of the SRS resource used for the measurements. In certain configurations, the UE skips SRS-RSRP measurements for a time unit where GB resources are not available based on an indication received from the base station via a higher layer parameter. In certain configurations, the higher layer parameter includes a bitmap that indicates a specific set of time units in which SRS-RSRP measurements are to be skipped.

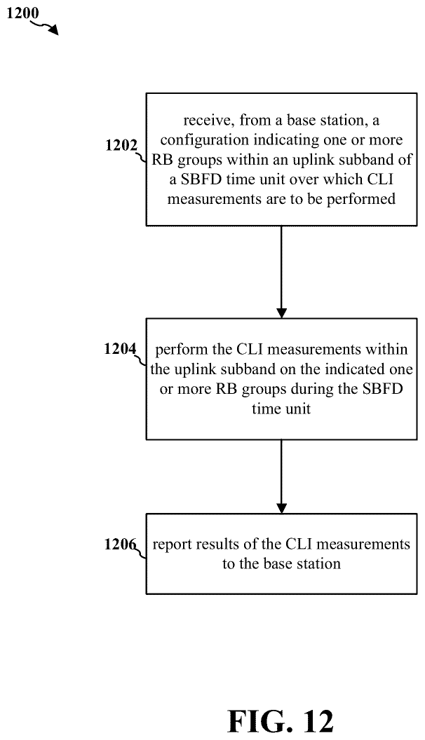

FIG. 12 is a flow chart 1200 of a method for performing cross-link interference (CLI) measurements and reporting the measurement results to a base station. The method may be performed by a user equipment (UE) (e.g., the UE 704).

In operation 1202, the UE receives, from a base station, a configuration indicating one or more resource block (RB) groups within an uplink subband of a subband full-duplexing (SBFD) time unit over which CLI measurements are to be performed. In certain configurations, the SBFD time unit is a slot or a symbol. In operation 1204, the UE performs the CLI measurements within the uplink subband on the indicated one or more RB groups during the SBFD time unit.

In operation 1206, the UE reports results of the CLI measurements to the base station. The results include one or more RB group indices to indicate the one or more RB groups on which CLI was measured. In certain configurations, the results include, for each RB group, an index of an RB with a highest CLI among the RBs of that RB group. In certain configurations, the results include indices of one or more RBs, in an RB group, on which the measured CLI exceeds a predefined threshold. In certain configurations, to report the results, the UE further reports time and frequency locations at which CLI measurements were performed. The time location may indicate a time unit in which CLI was measured. The frequency locations may indicate a specific resource block in which CLI was measured.

In certain configurations, the UE receives an indication from the base station to skip CLI measurements for one or more time units. The indication may include a bitmap, each bit indicating whether CLI measurements are to be skipped in a corresponding time unit.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a sounding reference signal (SRS) configuration from a base station; and
transmitting a sounding reference signal (SRS) within a guard band (GB) frequency range in a frequency band during a subband full-duplexing (SBFD) time unit based on the SRS configuration.

2. The method of claim 1, wherein the SRS configuration specifies a frequency range in which the SRS is to be transmitted.

3. The method of claim 2, wherein the frequency range contains an integer number of resource blocks (RBs) within the GB that are other than multiples of four for RB allocation.

4. The method of claim 1, wherein the SRS configuration specifies a comb factor for the SRS transmission, the comb factor determining a frequency domain resource sharing interval among multiple UEs.

5. The method of claim 1, further comprising:
receiving, from the base station, a higher layer parameter that indicates a specific set of time units in which an SRS transmission within the GB frequency range are to be skipped.

6. The method of claim 1, wherein the UE generates an SRS sequence for transmission within the GB frequency range, the SRS sequence being mapped to SRS resources configured by the SRS configuration and capable of being repeated over multiple symbols.

7. The method of claim 1, wherein a GB comprises the GB frequency range and is contiguous in a frequency domain, wherein the UE is configured to perform SRS transmission in the GB frequency range.

8. The method of claim 1, wherein a GB is non-contiguous in a frequency domain and comprises the GB frequency range and another frequency range, wherein the UE is configured to perform SRS transmission in the GB frequency range and in the another frequency range.

9. A method of wireless communication of a user equipment (UE), comprising:
receiving a sounding reference signal (SRS) reference signal received power (RSRP) measurement configuration from a base station;
performing SRS-RSRP measurements based on the received SRS-RSRP measurement configuration within a guard band (GB) in a frequency band during a subband full-duplexing (SBFD) time unit; and
reporting SRS-RSRP measurement results to the base station.

10. The method of claim 9, wherein the SRS-RSRP measurement configuration indicates more than one symbol for performing the SRS-RSRP measurements.

11. The method of claim 9, further comprising skipping SRS-RSRP measurements for a time unit where GB resources are not available based on an indication received from the base station via a higher layer parameter.

12. The method of claim 9, wherein the GB comprises non-contiguous frequency resources and wherein performing the SRS-RSRP measurements comprises:
performing a first SRS-RSRP measurement on an SRS resource in a first portion of the GB;
performing a second SRS-RSRP measurement on the SRS resource in a second portion of the GB; and
combining results of the first and second SRS-RSRP measurements.

13. The method of claim 9, wherein the GB comprises contiguous frequency resources and wherein performing the SRS-RSRP measurements comprises:
performing a first SRS-RSRP measurement on a first SRS resource in the GB,
the method further comprising:
performing a second SRS-RSRP measurement on a second SRS resource in another GB in the frequency band.

14. A method of wireless communication of a user equipment (UE), comprising:
receiving, from a base station, a configuration indicating one or more resource block (RB) groups within an uplink subband of a subband full-duplexing (SBFD) time unit over which cross-link interference (CLI) measurements are to be performed;
performing the CLI measurements within the uplink subband on the indicated one or more RB groups during the SBFD time unit; and
reporting results of the CLI measurements to the base station, the results including one or more RB group indices to indicate the one or more RB groups on which CLI was measured.

15. The method of claim 14, wherein the results comprises:
for each RB group, an index of an RB with a highest CLI among the RBs of that RB group.

16. The method of claim 14, wherein the results comprises:
indices of one or more RBs, in an RB group, on which the measured CLI exceeds a predefined threshold.

17. The method of claim 14, further comprising:
receiving an indication from the base station to skip CLI measurements for one or more time units.

18. The method of claim 14, wherein reporting the results further comprises:
reporting time and frequency locations at which CLI measurements were performed.

19. The method of claim 18, wherein the time location indicates a time unit in which CLI was measured.

20. The method of claim 18, wherein the frequency locations indicate a specific resource block in which CLI was measured.
